(19) United States
(12) Patent Application Publication
(10) Pub. No.: US 2011/0028025 A1
(43) Pub. Date: Feb. 3, 2011

(54) CONNECTING DEVICE FOR A MULTICONDUCTOR ELECTRIC CABLE

(76) Inventor: Albert Ferderer, Espelkamp (DE)

Correspondence Address: HAYES SOLOWAY P.C., 3450 E. SUNRISE DRIVE, SUITE 140, TUCSON, AZ, 85718, US

(21) Appl. No.: 12/834,698

(22) Filed: Jul. 12, 2010

(30) Foreign Application Priority Data
Jul. 29, 2009 (DE) 20 2009 010 246.7

(51) Int. Cl. H01R 4/24

(52) U.S. Cl. 439/404

(57) ABSTRACT

The invention pertains to a connecting device for a multiconductor electric cable that features a carrier body (11) and comprises several connecting units (1), wherein each connecting unit features a chamber (12) with an insulation displacement termination (15) that is arranged in the carrier body and each conductor is inserted into the corresponding chamber (12) axially referred to the corresponding insulation displacement termination (15), and wherein the invention proposes to provide exactly one slide (13) for each chamber (12) in order to press the conductor that transversely extends through the chamber (12) into the respective insulation displacement termination (15). This makes it possible to contact each conductor individually, manually and with a correspondingly low expenditure of force and a simple tool. The described arrangement therefore can be assembled on site. The contact of each individual conductor can also be interrupted again.

### BACKGROUND OF THE INVENTION

1. Field of the Invention

The invention pertains to a connecting device for a multiconductor electric cable, wherein the connecting device features a carrier body and comprises several connecting units, wherein each connecting unit features a chamber with a contact element that is arranged in the carrier body, wherein the contact element is provided with an insulation displacement termination on at least one end, and wherein each connecting unit is designed for accommodating and contacting an individual conductor of the multiconductor electric cable that is inserted into the connecting unit axially referred to the insulation displacement termination.

An insulation displacement connector of this type is required, for example, for contacting a multiconductor cable to be installed on a printed circuit board.

2. Description of the Related Art

An electric connector for connecting insulated electric conductors is known from the state of the art, for example, according to publication EP0554810B1. In order to contact the connector, all electric conductors to be contacted are inserted into a common pressure member in a first process, namely such that they are respectively aligned axially referred to insulation displacement terminations provided in the connector in order to contact the conductors. The electric conductors are then jointly pressed into their respective insulation displacement terminations in a second process by actuating the pressure member.

In this case, it is disadvantageous that the contacting process can only be carried out in this fashion with a correspondingly high expenditure of force and that all conductors to be contacted need to be previously inserted into the pressure member and held therein, namely without each individual conductor initially being correspondingly fixed in position. Consequently, this known device essentially is suitable for mechanized contacting processes. This means that there is a need for a corresponding connecting device that can be assembled on site and makes it possible to manually contact several individual conductors at the work site with a simple tool and a low expenditure of force.

### SUMMARY OF THE INVENTION

The invention therefore is based on the objective of disclosing a connecting device of the initially cited type that can be assembled on site, inexpensively manufactured and makes it possible to contact several conductors with a low expenditure of force and a simple tool.

This objective is attained in that each connecting unit features a slide that is at least partially inserted into the corresponding chamber and provided with a guide opening that extends axially referred to the insulation displacement termination, wherein the end of the guide opening transforms into a corresponding deflection bevel or deflection curvature such that the respective slide is suitable for pressing the conductor that is initially inserted into the guide opening and then transversely extends through the chamber into the corresponding insulation displacement termination when it is actuated accordingly.

Advantageous embodiments of the invention are disclosed in Claims 2-6. The invention concerns a connecting unit for axially inserted stranded conductors that is used in print terminals, series terminals and printed circuit board connectors and makes it possible to successively actuate the individual termination points.

The advantages attained with the invention can be seen, in particular, in that each individual conductor is initially inserted into the guide opening of the respective slide axially referred to the insulation displacement termination, cut to the corresponding length, if applicable, and then immediately contacted and fixed independently of the other conductors by actuating the respective slide. This significantly simplifies the manual contacting process in comparison with an arrangement, into which all cables need to be initially inserted and then jointly contacted. In addition, the expenditure of force required for the contacting process is also reduced because the contacting of the individual conductors is carried out successively. Consequently, the manual contacting can be inexpensively realized, for example, with a screwdriver on site, i.e., at the work site such as, for example, directly at the customer. In this case, the screwdriver can be inserted into a recess provided on the slide for this purpose in the moving direction thereof in order to press down the slide toward the insulation displacement termination or the screwdriver can push the slide in and out of the chamber through a window provided in the carrier body. In this context, it is particularly advantageous if the slide can be pushed into and out of the chamber through the window of the carrier body by means of a lever arm because the required expenditure of force is additionally reduced in this fashion. It is particularly advantageous if the slide is at least partially pushed out because this makes it possible to interrupt an existing contact.

The contacting of any number of contacts can be realized in this fashion. For many applications, it is particularly advantageous that the conductor is inserted axially referred to the insulation displacement termination. This also reduces the space requirement of the corresponding arrangement for many applications. This opens up other fields of application for connectors of the initially cited type such as, e.g., the manual connection of axially inserted stranded conductors in print terminals, series terminals and printed circuit board connectors, particularly also for arrangements, for which only a small area is available.

In one preferred embodiment, each connecting unit features a window. For example, a lever in the form of a screwdriver can be inserted into a recess provided on the slide through this window in order to move the slide by means of a lever arm. The slide can be at least partially pushed out of the chamber in this fashion. An existing contact is immediately interrupted. Vice versa, the conductor can also be contacted by correspondingly pushing the slide into the chamber with a low expenditure of force by means of the lever arm.

In another preferred embodiment, the conductor to be contacted initially protrudes from a recess provided on the end of the deflection bevel or deflection curvature of the slide that was not yet pushed into the chamber and therefore can, for example, be cut to the desired length.

In another embodiment, at least one insulation displacement termination and a conductor rail are jointly manufactured in the form of an integral component by means of punching and bending.

### BRIEF DESCRIPTION OF THE DRAWINGS

One exemplary embodiment of the invention is illustrated in the drawing and described in greater detail below. In the drawing:

FIG. 1 shows a connecting unit.

### DETAILED DESCRIPTION OF THE PREFERRED EMBODIMENTS

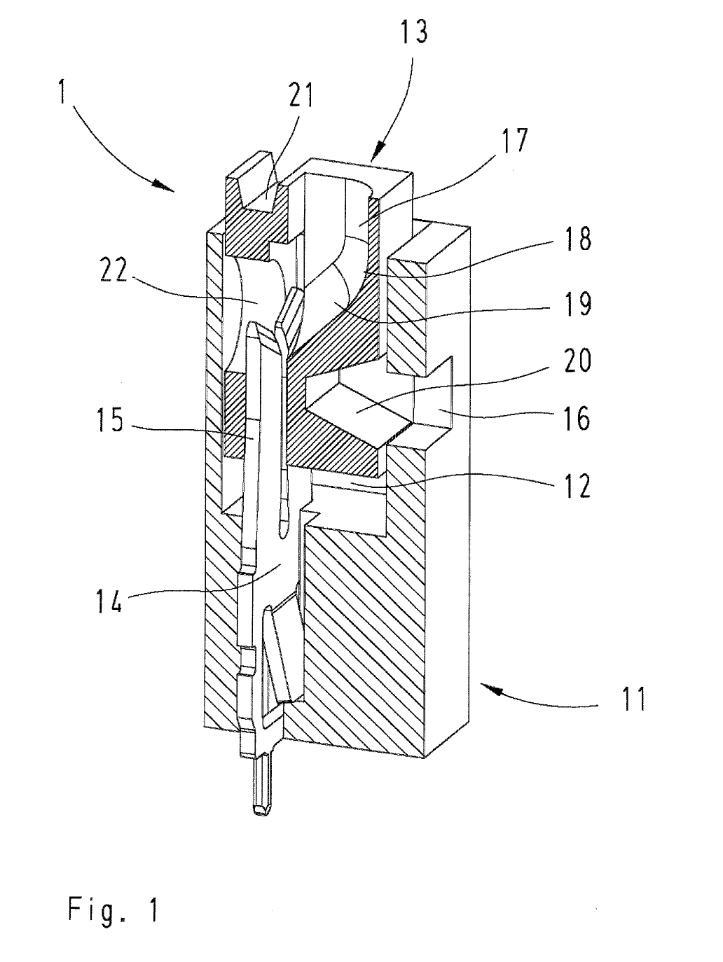

Only one individual connecting unit 1 is illustrated in FIG. 1 in order to provide a better overview. This connecting unit 1 comprises part of the carrier body 11, a chamber 12, a slide 13 and a contact element 14 with an insulation displacement termination 15 that protrudes into the chamber 12.

The slide 13 already is partially inserted into the chamber 12 and can be completely pushed into the chamber 12. The slide 13 features a guide opening 17. This guide opening 17 begins at a face of the slide 13 that protrudes out of the chamber 12 and initially extends along the moving direction of the slide 13. On its end, the guide opening 17 transforms into a deflection bevel 19 by means of a curvature 18 and ends in an outlet opening 22 that is separated from the deflection bevel by the insulation displacement termination 15. The guide opening 17 serves for accommodating a conductor inserted therein such that it is aligned axially referred to the insulation displacement termination 15. The deflection bevel 19 of the slide 13 serves for transversely guiding the conductor through the chamber 12. The end of a conductor may protrude out of the outlet opening 22 of a slide 13 that was not yet pushed into the chamber 12 and therefore can be cut off accordingly. The slide 13 is then able to press the conductor that advantageously protrudes over the insulation displacement termination 15 by a corresponding distance into the insulation displacement termination 15 when it is actuated accordingly, namely when the slide 13 is pushed deeper or even completely into the chamber 12.

The slide 13 furthermore features a recess 20 that makes it possible to push the slide 13 into and out of the chamber 12 with a tool in the form of a lever arm, particularly a screwdriver, in connection with a window 16 that leads into the chamber 12 through the carrier body 11. Consequently, it is possible, in particular, to at least partially push the slide 13 out of the chamber 12 and to thusly interrupt an existing contact. A conductor can also be contacted with a low expenditure of force by pushing the slide 13 into the chamber 12 by means of the lever arm.

Alternatively, the conductor can also be contacted with the insulation displacement termination 15 by inserting a corresponding tool such as, for example, a screwdriver into a recess 21 provided for this purpose in a face of the slide 13 that protrudes from the chamber 12, namely in the moving direction of the slide 13, and subsequently pressing the slide 13 deeper or completely into the chamber 12.

1. A connecting device for a multiconductor electric cable, wherein the connecting device features a carrier body and comprises several connecting units, wherein each connecting unit features a chamber with a contact element that is arranged in the carrier body, wherein the contact element is provided with an insulation displacement termination on at least one end, and wherein each connecting unit is designed for accommodating and contacting an individual conductor of the multiconductor electric cable that is inserted into the connecting unit axially referred to the insulation displacement termination, wherein each connecting unit features a slide that is at least partially inserted into the corresponding chamber and provided with a guide opening that extends axially referred to the insulation displacement termination, wherein the end of the guide opening transforms into a corresponding deflection bevel or deflection curvature such that the respective slide is suitable for pressing the conductor that is initially inserted into the guide opening and then transversely extends through the chamber into the corresponding insulation displacement termination when it is actuated accordingly.

2. The connecting device according to claim 1, wherein each connecting unit features a window in the carrier body, wherein said window is provided for pushing the slide into the chamber and/or for pushing the slide out of the chamber.

3. The connecting device according to claim 2, wherein the slide features a recess provided for inserting the lever therein through the window.

4. The connecting device according to claim 1, wherein the slide features a recess on a face that protrudes from the chamber, wherein said recess is provided for inserting a suitable tool such as, for example, a screwdriver therein axially referred to the moving direction of the slide in order to push the slide into the chamber.

5. The connecting device according to claim 1, wherein at least one of the contact elements and a conductor rail are jointly manufactured in the form of an integral component.

6. The connecting device according to claim 5, wherein the at least one contact element and the conductor rail are jointly manufactured by punching and bending.

7. The connecting device according to claim 2, wherein the slide features a recess on a face that protrudes from the chamber, wherein said recess is provided for inserting a suitable tool such as, for example, a screwdriver therein axially referred to the moving direction of the slide in order to push the slide into the chamber.

8. The connecting device according to claim 3, wherein the slide features a recess on a face that protrudes from the chamber, wherein said recess is provided for inserting a suitable tool such as, for example, a screwdriver therein axially referred to the moving direction of the slide in order to push the slide into the chamber.

9. The connecting device according to claim 2, wherein at least one of the contact elements and a conductor rail are jointly manufactured in the form of an integral component.

10. The connecting device according to claim 3, wherein at least one of the contact elements and a conductor rail are jointly manufactured in the form of an integral component.

11. The connecting device according to claim 4, wherein at least one of the contact elements and a conductor rail are jointly manufactured in the form of an integral component.
